(19) United States
(12) Patent Application Publication
(10) Pub. No.: US 2025/0297907 A1
(43) Pub. Date: Sep. 25, 2025

(54) PRESSURE SENSOR

(71) Applicant: TDK Corporation, Tokyo (JP)

(72) Inventors: Masanori KOBAYASHI, Tokyo (JP); Ken UNNO, Tokyo (JP); Tetsuya SASAHARA, Tokyo (JP); Tetsuo HATA, Tokyo (JP); Lucie OUEDRAOGO, Tokyo (JP)

(73) Assignee: TDK Corporation, Tokyo (JP)

(21) Appl. No.: 19/077,317

(22) Filed: Mar. 12, 2025

(30) Foreign Application Priority Data
Mar. 25, 2024 (JP) 2024-048534

(51) Int. Cl. G01L 9/00

(52) U.S. Cl. CPC G01L 9/0064; G01L 2009/0066

(57) ABSTRACT

A pressure sensor includes a stem including a base wall and a side wall extending in a first direction crossing the base wall; a first resistive film pattern provided in an outer region of an outer base surface of the base wall, the outer region overlying the side wall in plan view from the first direction; and a second resistive film pattern provided at least partly in an inner region of the outer base surface, the inner region not overlying the side wall in plan view from the first direction. The first resistive film pattern includes circumferentially oriented pattern portions connected with a turn, the circumferentially oriented pattern portions extending along a circumferential direction and having different distances from a center of the outer base surface.

### CROSS-REFERENCE TO RELATED APPLICATIONS

The present application claims a priority to Japanese patent application No. 2024-048534 filed on Mar. 25, 2024, which is incorporated herein by reference in its entirety.

### BACKGROUND

The present disclosure relates to a pressure sensor including a stem.

Suggested as a sensor (e.g., pressure sensor) is a technique of forming a resistive film pattern on an outer base surface of a metal stem (see, for example, Patent Document 1).

Suggested as a technique of forming a resistive film pattern on an outer base surface of a metal stem is a technique of forming a temperature-detecting resistive film in an outer region of the outer base surface and a pressure-detecting resistive film in an inner region of the outer base surface. Although resistance of the pressure-detecting resistive film is affected by temperature, a pressure sensor including the separate temperature-detecting resistive film can find a pressure value in which the influence of temperature is eliminated from an output.
Patent Document 1: EP2554964 (A2) Specification

### SUMMARY

A pressure sensor according to the present disclosure includes:
a stem including a base wall and a side wall extending in a first direction crossing the base wall;
a first resistive film pattern provided in an outer region of an outer base surface of the base wall, the outer region overlying the side wall in plan view from the first direction; and
a second resistive film pattern provided at least partly in an inner region of the outer base surface, the inner region not overlying the side wall in plan view from the first direction,
wherein
the first resistive film pattern comprises circumferentially oriented pattern portions connected with a turn, the circumferentially oriented pattern portions extending along a circumferential direction and having different distances from a center of the outer base surface.

### BRIEF DESCRIPTION OF THE DRAWING(S)

FIG. 1 is a schematic sectional view of a pressure sensor according to a first embodiment.

FIG. 2 is a top view of the pressure sensor shown in FIG. 1 viewed from a first direction in plan view.

FIG. 3 is a schematic view illustrative of circumferentially oriented pattern portions of a first resistive film pattern of the pressure sensor shown in FIG. 2.

FIG. 4 is a schematic view of a relationship between a side wall of a stem and regions of an outer base surface of the stem of the pressure sensor shown in FIG. 2.

FIG. 5 is a schematic view of strain tendencies in the pressure sensor shown in FIG. 2.

FIG. 6 is a more detailed schematic view of the strain tendencies shown in FIG. 5.

FIG. 7 is a schematic view illustrative of circumferentially oriented pattern portions of a first resistive film pattern according to a first modified example.

FIG. 8 is a schematic view illustrative of circumferentially oriented pattern portions of a first resistive film pattern according to a second modified example.

FIG. 9 is a schematic view illustrative of circumferentially oriented pattern portions of a first resistive film pattern according to a third modified example.

FIG. 10 is a schematic view of a relationship between a side wall of a stem and regions of an outer base surface of the stem of a pressure sensor according to a second embodiment.

FIG. 11 is a schematic view of a relationship between a side wall of a stem and regions of an outer base surface of the stem of a pressure sensor according to a third embodiment.

FIG. 12 is a schematic view of a pressure sensor according to a reference example.

### DETAILED DESCRIPTION

However, in a conventional pressure sensor, its resistive film pattern provided in an outer region of an outer base surface has a shape in which radial patterns extending along a radial direction are connected with turns. Thus, in the conventional pressure sensor, an output of its temperature-detecting resistive film is readily affected by strain of the outer base surface; and this unfortunately impairs accuracy of temperature detection.

It is desirable to provide a pressure sensor including a resistive film pattern that is not readily affected by strain of an outer base surface and is capable of highly accurate temperature detection.

Hereinafter, the present disclosure is described with reference to embodiments illustrated in the drawings.

### First Embodiment

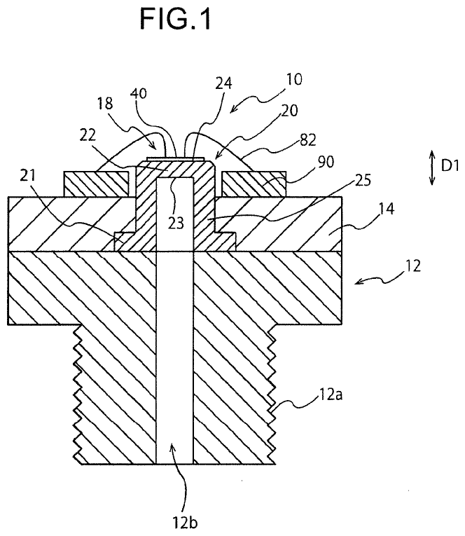

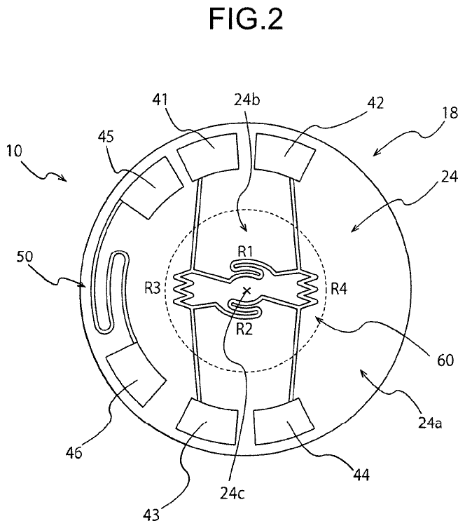

FIG. 1 is a schematic sectional view of a pressure sensor 10 including a stem 20 according to a first embodiment. As shown in FIG. 1, the pressure sensor 10 includes the stem 20, which includes a base wall 22 and a side wall 25, and a sensor unit 18, which is provided on an outer base surface 24 of the base wall 22, with an insulating film 40 interposed between the sensor unit 18 and the outer base surface 24. The sensor unit 18 includes a first resistive film pattern 50 and a second resistive film pattern 60 (see FIG. 2) described later.

As shown in FIG. 1, the stem 20 has a hollow cylindrical shape and includes the base wall 22 and the side wall 25 extending in a first direction D1 crossing the base wall 22. At one end of the side wall 25 in the first direction D1, the base wall 22 is provided. A portion (an inner region 24b described later) of the base wall 22 is a membrane where strain is generated by pressure of a fluid whose pressure is subject to measurement.

By contrast, an other end of the side wall 25 in the first direction D1 is an open end of hollowness inside the stem 20. The hollowness inside the stem 20 communicates with a flow path 12b of a connecting member 12. The first direction D1, in which the side wall 25 extends, may be substantially perpendicular to a direction in which the outer base surface 24 of the base wall 22 extends as shown in FIG. 1; however, the side wall 25 may be inclined so that the hollowness widens from the base wall 22 to the open end.

As shown in FIG. 1, in the pressure sensor 10, a fluid introduced into the flow path 12b is introduced to an inner base surface 23 of the base wall 22 through the hollowness of the stem 20 to exert fluid pressure on the inner base surface 23 and the base wall 22. The stem 20 is made from, for example, metal (e.g., stainless steel).

At the other end of the side wall 25 of the stem 20, a flange portion 21 is provided. The flange portion 21 is provided so as to protrude radially outwards from the side wall 25. The flange portion 21 being fastened between the connecting member 12 and a holding member 14 seals the flow path 12b leading to the inner base surface 23 of the base wall 22.

The connecting member 12 has a thread groove 12a for connecting the pressure sensor 10 to plumbing, an external flow path, or the like. Using the thread groove 12a, the pressure sensor 10 is fastened to, for example, a pressure vessel containing a fluid subject to pressure measurement. The flow path 12b inside the connecting member 12 and the hollowness of the stem 20 thus airtightly communicate with the pressure vessel containing the fluid subject to pressure measurement.

To an upper surface of the holding member 14, a circuit substrate 90 is attached as a signal transmission unit. The circuit substrate 90 has a ring shape surrounding the stem 20; however, the shape of the circuit substrate 90 is not limited to the ring shape. The circuit substrate 90 includes, for example, a built-in circuit to which a detection signal is transmitted from the sensor unit 18 (see FIG. 2) provided on the outer base surface 24 of the stem 20. The circuit substrate 90 is electrically connected to, for example, electrode pads 41 to 46 (see FIG. 2) of the sensor unit 18 via a connecting wire 82 using wire bonding or the like.

FIG. 2 is a top view of the pressure sensor 10 shown in FIG. 1, showing the outer base surface 24 of the stem 20 viewed from the first direction D1 in plan view. As shown in FIG. 2, on the outer base surface 24, the first resistive film pattern 50 and the second resistive film pattern 60 are provided. As shown in FIG. 2, the first resistive film pattern 50 is in an outer region 24a of the outer base surface 24 of the base wall 22; and the second resistive film pattern 60 is in the inner region 24b, which is closer than the outer region 24a to a center 24c of the outer base surface 24, of the outer base surface 24 of the base wall 22.

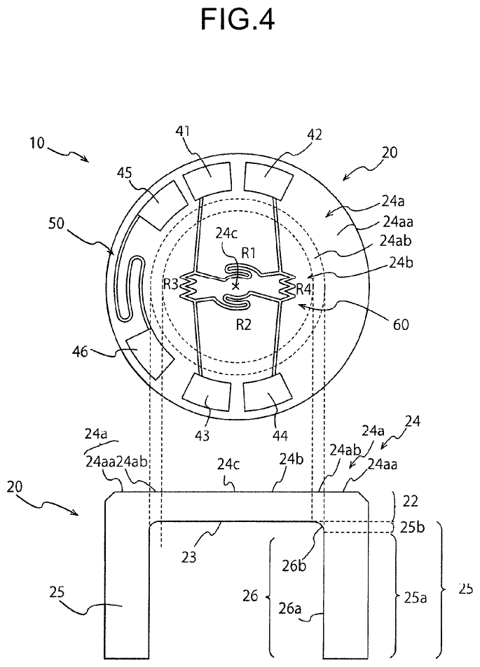

FIG. 4 is a schematic view illustrative of the outer region 24a and the inner region 24b of the outer base surface 24 shown in FIG. 2. Disposed at an upper part of FIG. 4 is a plan view of the outer base surface 24 of the stem 20 viewed from the first direction D1; and disposed at a lower part of FIG. 4 is a sectional view of the stem 20 in a section that is parallel to the first direction D1 and passes the center 24c of the outer base surface 24.

As shown in FIG. 4, the outer region 24a of the outer base surface 24 overlies the side wall 25 of the stem 20 in plan view from the first direction D1. By contrast, the inner region 24b of the outer base surface 24 does not overlie the side wall 25 of the stem 20 in plan view from the first direction D1.

As shown in the sectional view of the stem 20 in FIG. 4, the side wall 25 includes a first side wall portion 25a and a second side wall portion 25b. A first inner surface 26a of the first side wall portion 25a extends in the first direction D1. A second inner surface 26b of the second side wall portion 25b faces a direction in between the first inner surface 26a of the first side wall portion 25a and the inner base surface 23 of the base wall 22. The second inner surface 26b of the second side wall portion 25b connects the first inner surface 26a of the first side wall portion 25a and the inner base surface 23.

The first inner surface 26a of the first side wall portion 25a and the second inner surface 26b of the second side wall portion 25b constitute an inner surface 26 of the side wall 25. The first inner surface 26a of the first side wall portion 25a has a substantially cylindrical side surface shape. The second inner surface 26b of the second side wall portion 25b can be a rounded surface of revolution presenting a curve in sectional view or a tapered surface of revolution presenting a straight line in sectional view; however, details of the shape of the second inner surface 26b are not limited.

As shown in FIG. 4, the outer region 24a of the outer base surface 24 includes a first outer region 24aa, which overlies the first side wall portion 25a in plan view, and a second outer region 24ab, which overlies the second inner surface 26b of the second side wall portion 25b in plan view. The first resistive film pattern 50 of the first embodiment entirely overlies the first side wall portion 25a in plan view from the first direction D1 and is provided in the first outer region 24aa. Arrangement of the first resistive film pattern 50 in its entirety in the first outer region 24aa can effectively prevent influence of strain of the base wall 22 on resistance of the first resistive film pattern 50. That is, arrangement of the first resistive film pattern in its entirety in the outer region's portion that is less readily affected by strain of the outer base surface allows more accurate temperature detection.

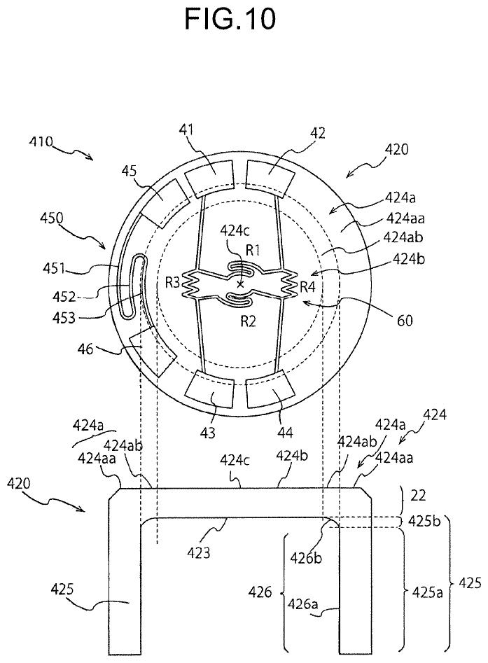

However, an embodiment (see FIG. 10) in which the first resistive film pattern is partly provided in the second outer region 24ab or an embodiment in which the first resistive film pattern is partly provided in the inner region 24b or the like other than the outer region 24a is conceivable. Alternatively, an embodiment in which the second resistive film pattern 60 is partly provided in the outer region 24a or the like (e.g., second outer region 24ab) other than the inner region 24b is conceivable. Also, an outer edge of the outer base surface 24 may be chamfered or rounded as shown in FIG. 1 or FIG. 4; or the outer edge may be a continuation of a flat surface from inside. Such an outer edge of the outer base surface 24 is also included in the outer base surface 24.

The second resistive film pattern 60 shown in FIG. 2 includes resistors R1, R2, R3, and R4 at predetermined locations of the outer base surface 24. Resistance of the resistors R1 to R4 of the second resistive film pattern 60 changes according to strain of the base wall 22 generated by pressure of a fluid subject to measurement. The resistors R1 to R4 included in the second resistive film pattern 60 are connected so as to constitute a Wheatstone bridge circuit. In the example shown in FIGS. 2 and 4, the resistors R1 to R4 included in the second resistive film pattern 60 are provided inwards from the first resistive film pattern 50 as a whole.

Changes in the resistance of the resistors R1 to R4 included in the second resistive film pattern 60 are transmitted to the circuit substrate 90 (see FIG. 1) or the like via the electrode pads 41, 42, 43, and 44, to which the second resistive film pattern 60 is connected. The pressure sensor 10 detects pressure of a fluid subject to pressure measurement using an output of the second resistive film pattern 60. Note that the number of the resistors R1 to R4 included in the second resistive film pattern 60 or the specific circuit configuration of the second resistive film pattern 60 are not limited to those shown in FIG. 2; and the second resistive film pattern 60 can have any number of resistors and any circuit configuration with which strain of the base wall 22 can be detected.

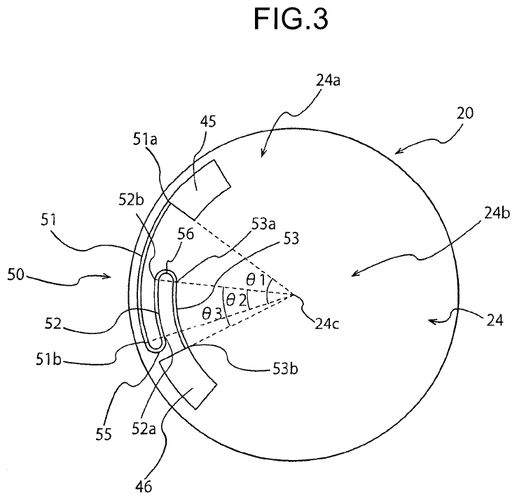

Similarly to FIG. 2, FIG. 3 is a plan view of the outer base surface 24 of the stem 20 from the first direction D1. However, in FIG. 3, among portions of the sensor unit 18 provided on the outer base surface 24, illustrations of structures other than the first resistive film pattern 50 and the electrode pads 45 and 46 are omitted.

As shown in FIG. 3, the first resistive film pattern 50 includes a first circumferentially oriented pattern portion 51, a second circumferentially oriented pattern portion 52, and a third circumferentially oriented pattern portion 53, which are circumferentially oriented pattern portions that extend along a circumferential direction and have different distances from the center 24c of the outer base surface 24. The first circumferentially oriented pattern portion 51, the second circumferentially oriented pattern portion 52, and the third circumferentially oriented pattern portion 53, which are the circumferentially oriented pattern portions, are connected with turns to constitute the first resistive film pattern 50. The first resistive film pattern 50 also includes a connecting portion 55, which connects the first circumferentially oriented pattern portion 51 and the second circumferentially oriented pattern portion 52, and a connecting portion 56, which connects the second circumferentially oriented pattern portion 52 and the third circumferentially oriented pattern portion 53.

As shown in FIG. 2, the first circumferentially oriented pattern portion 51 is located most peripherally among the multiple (in the first embodiment, three) circumferentially oriented pattern portions. The second circumferentially oriented pattern portion 52 is disposed closer than the first circumferentially oriented pattern portion 51 to the center 24c of the outer base surface 24. The third circumferentially oriented pattern portion 53 is disposed still closer than the first and the second circumferentially oriented pattern portions 51 and 52 to the center 24c of the outer base surface 24.

As shown in FIG. 3, at least a part of the first circumferentially oriented pattern portion 51, at least a part of the second circumferentially oriented pattern portion 52, and at least a part of the third circumferentially oriented pattern portion 53 are disposed concentrically with respect to the center 24c of the outer base surface 24. One end 51a of the first circumferentially oriented pattern portion 51 is connected to the electrode pad 45. An other end 51b of the first circumferentially oriented pattern portion 51 and one end 52a of the second circumferentially oriented pattern portion 52 are connected by the connecting portion 55 having a substantially semicircular shape with a larger curvature than curvatures of the circumferentially oriented pattern portions 51 and 52.

An other end 52b of the second circumferentially oriented pattern portion 52 and one end 53a of the third circumferentially oriented pattern portion 53 are connected by the connecting portion 56 having a substantially semicircular shape with a larger curvature than curvatures of the circumferentially oriented pattern portions 52 and 53. An other end 53b of the third circumferentially oriented pattern portion 53 is connected to the electrode pad 46. In this manner, in the first resistive film pattern 50, the circumferentially oriented pattern portions 51 and 52 extending along the circumferential direction are connected so that, from the viewpoint of the one end 51a of the first circumferentially oriented pattern portion 51, the conduction path turns counterclockwise and then clockwise using the connecting portion 55. Also, the circumferentially oriented pattern portions 52 and 53 extending along the circumferential direction are connected so that, from the viewpoint of the one end 52a of the second circumferentially oriented pattern portion 52, the conduction path turns clockwise and then counterclockwise using the connecting portion 56.

As shown in FIG. 3, an angle θ1 subtended by an arc between the one end 51a and the other end 51b of the first circumferentially oriented pattern portion 51 at the center 24c is larger than an angle θ2 subtended by an arc between the one end 52a and the other end 52b of the second circumferentially oriented pattern portion 52 at the center 24c and an angle θ3 subtended by an arc between the one end 53a and the other end 53b of the third circumferentially oriented pattern portion 53 at the center 24c. The second circumferentially oriented pattern portion 52 and the third circumferentially oriented pattern portion 53 are the circumferentially oriented pattern portions other than the first circumferentially oriented pattern portion 51.

Because the first circumferentially oriented pattern portion 51, which is least readily affected by strain, has a long length in such a pressure sensor 10, influence of strain of the outer base surface 24 on changes in the resistance of the first resistive film pattern 50 can more effectively be mitigated. Also, the circumferentially oriented pattern portions 52 and 53 other than the first circumferentially oriented pattern portion 51 being included in the first resistive film pattern 50 can extend the length of the first resistive film pattern 50 to enhance accuracy of temperature detection.

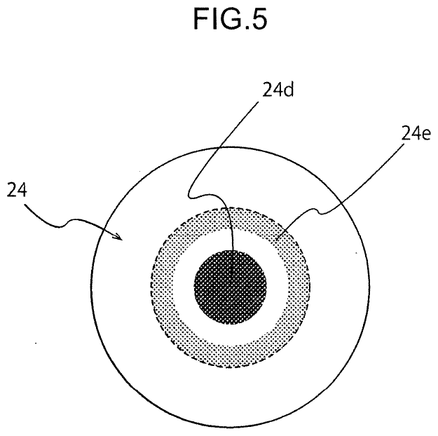

FIG. 5 shows a θ-strain region 24d and an R-strain region 24e, which are regions of the outer base surface 24 of the stem 20. The θ-strain region 24d is under heavy strain (tension, +) along the θdirection (circumferential direction). The R-strain region 24e is under heavy strain (compression, −) along an R direction (radial direction). The θ-strain region 24d is near the center 24c of the outer base surface 24 and extends inside the inner region 24b. By contrast, the R-strain region 24e extends near a border between the first outer region 24aa and the second outer region 24ab (inwards from the border between the first outer region 24aa and the second outer region 24ab).

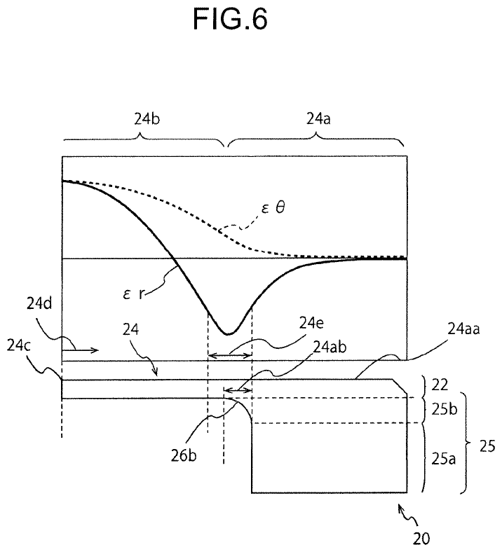

FIG. 6 is a graph showing the magnitude of strain ϑθ along the θ direction (circumferential direction) and the magnitude of strain εR along the R direction (radial direction) of the outer base surface 24 of the stem 20, corresponding to their locations on the outer base surface 24. As is understandable from FIG. 6, in the outer region 24a, the absolute value of the strain εθ along the θ direction and the absolute value of the strain εR along the R direction tend to become smaller from the inner side to the outer side. Also, in the outer region 24a, the absolute value of the strain εθ along the θ direction as a whole tends to be smaller than the absolute value of the strain εR along the R direction. In other words, with regard to strain of the outer region of the outer base surface accompanying pressure applied by a target, the strain in the radial direction tends to be larger than the strain in the circumferential direction. The resistance of the circumferentially oriented pattern portions 51, 52, and 53 extending along the circumferential direction is less readily affected by the strain εR along the R direction. Thus, in the pressure sensor including the circumferentially oriented pattern portions 51, 52, and 53 extending along the circumferential direction and being connected with turns as shown in FIG. 3, the length of the resistive film can be increased while influence of strain of the outer base surface can be mitigated. The pressure sensor is thus capable of highly accurate temperature detection.

In plan view, the first circumferentially oriented pattern portion 51, the second circumferentially oriented pattern portion 52, and the third circumferentially oriented pattern portion 53 shown in FIG. 3 have an arc shape having, as a center, the center 24c of the outer base surface 24; however, even if the circumferentially oriented pattern portions have other shapes slightly different from the arc shape, provided that the circumferentially oriented pattern portions run approximately along the circumferential direction, they can be determined as circumferentially oriented pattern portions extending along the circumferential direction. For example, a predetermined portion of the first resistive film pattern can be determined as a circumferentially oriented pattern portion extending along the circumferential direction when a mathematical formula 1 shown below is satisfied, where R01 denotes the distance from the center 24c to one end of the predetermined portion, R02 (R01≥R02) denotes the distance from the center 24c to an other end of the predetermined portion, and Δθ denotes the angle subtended by an arc between the one end and the other end at the center 24c.

Δθ/2π>(R01−R02)/R01 Mathematical formula 1

Changes in the resistance of the resistor constituting the first resistive film pattern 50 are transmitted to the circuit substrate 90 (see FIG. 1) or the like via the electrode pads 45 and 46, to which the first resistive film pattern 50 is connected. The pressure sensor 10 can carry out, for example, temperature correction of an output of the second resistive film pattern 60 using an output of the first resistive film pattern 50.

Examples of material of the first resistive film pattern 50 and the second resistive film pattern 60 include conductive strain resistance films containing a metal (e.g., Cr, Ni, Al, and Cu) or containing Cr, at least one of Ni, Al, and Cu, and at least one of N and O; however, the material is not limited. The first resistive film pattern 50 and the second resistive film pattern 60 are formed by, for example, patterning the strain resistance films formed with a thin film method into predetermined shapes. Similarly to the strain resistance films, the electrode pads 41 to 46 constitute conductive thin films. Examples of material of the electrode pads 41 to 46 include metals, such as Au, Al, and Ni.

As described above, the pressure sensor 10 includes the first resistive film pattern 50 made up of the circumferentially oriented pattern portions 51, 52, and 53 extending along the circumferential direction and being connected with turns. Because the resistance of such a first resistive film pattern 50 is less readily affected by strain of the outer base surface, highly accurate temperature detection is possible. Also, for example, through temperature correction of a detected value of the second resistive film pattern 60 using a detected value of the first resistive film pattern 50, the pressure sensor 10 can measure pressure with high accuracy in a wide temperature range.

Because the circumferentially oriented pattern portions 51, 52, and 53 are connected with turns to constitute the first resistive film pattern 50, the pressure sensor 10 can have a long length of the first resistive film pattern 50 in the conduction direction in a limited angular region in the circumferential direction. In such a pressure sensor 10, the electrode pads 41 to 46 and the like are readily disposed in the outer region 24a or the like without overlying the first resistive film pattern 50 for size reduction, and the first resistive film pattern 50 has its length ensured even in the limited region for accurate temperature detection.

In the pressure sensor 10, as shown in FIGS. 2, 3, and 4, the first circumferentially oriented pattern portion 51, which is least affected by strain, has a long length. Thus, influence of strain of the outer base surface 24 on changes in the resistance of the first resistive film pattern 50 can more effectively be mitigated. However, the shape of the first resistive film pattern included in the pressure sensor according to the present disclosure is not limited to the shape shown in FIG. 2. Needless to say, there are other various modified examples.

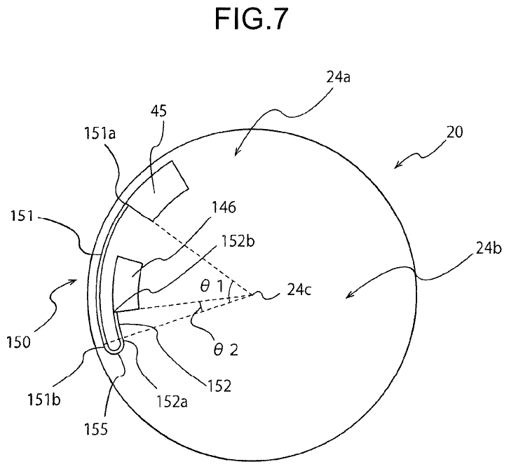

FIG. 7 is a schematic view of a shape of a first resistive film pattern 150 according to a first modified example and its arrangement with respect to the outer base surface 24. In FIG. 7, the outer base surface 24 of the stem 20 is illustrated in plan view from the first direction D1. However, in FIG. 7, among portions of the sensor unit provided on the outer base surface 24, illustrations of structures other than the first resistive film pattern 150, the electrode pad 45, and an electrode pad 146 are omitted.

Similarly to the first resistive film pattern 50 shown in FIG. 2, the first resistive film pattern 150 shown in FIG. 7 is provided in the outer region 24a, which overlies the side wall 25 (see FIG. 4) in plan view from the first direction D1, of the outer base surface 24.

The first resistive film pattern 150 includes a first circumferentially oriented pattern portion 151 and a second circumferentially oriented pattern portion 152, which are circumferentially oriented pattern portions that extend along the circumferential direction and have different distances from the center 24c of the outer base surface 24. The first circumferentially oriented pattern portion 151 and the second circumferentially oriented pattern portion 152, which are the circumferentially oriented pattern portions, are connected with a turn to constitute the first resistive film pattern 150. The first resistive film pattern 150 also includes a connecting portion 155, which connects the first circumferentially oriented pattern portion 151 and the second circumferentially oriented pattern portion 152.

The first circumferentially oriented pattern portion 151 is located most peripherally among the multiple (in the first modified example, two) circumferentially oriented pattern portions. At least a part of the first circumferentially oriented pattern portion 151 and at least a part of the second circumferentially oriented pattern portion 152 are disposed concentrically with respect to the center 24c of the outer base surface 24. One end 151a of the first circumferentially oriented pattern portion 151 is connected to the electrode pad 45. An other end 151b of the first circumferentially oriented pattern portion 151 and one end 152a of the second circumferentially oriented pattern portion 152 are connected by the connecting portion 155 having a substantially semicircular shape with a larger curvature than curvatures of the circumferentially oriented pattern portions 151 and 152. An other end 152b of the second circumferentially oriented pattern portion 152 is connected to the electrode pad 146.

The first resistive film pattern 150 includes the two circumferentially oriented pattern portions 151 and 152; however, the number of the circumferentially oriented pattern portions included in the first resistive film pattern 150 may be any plural number. The first resistive film pattern 150 includes the one connecting portion 155, where the first resistive film pattern 150 turns; however, the number of portions where the first resistive film pattern 150 turns is not limited to one or two and may be three or more.

As shown in FIG. 7, an angle θ1 subtended by an arc between the one end 151a and the other end 151b of the first circumferentially oriented pattern portion 151 at the center 24c is larger than an angle θ2 subtended by an arc between the one end 152a and the other end 152b of the second circumferentially oriented pattern portion 152, which is the circumferentially oriented pattern portion other than the first circumferentially oriented pattern portion 151, at the center 24c.

Because the first circumferentially oriented pattern portion 151, which is least readily affected by strain, has a long length and accounts for a large proportion of such a first resistive film pattern 150, influence of strain of the outer base surface 24 on changes in the resistance of the first resistive film pattern 150 can more effectively be mitigated.

The pressure sensor according to the present disclosure can include, instead of the first resistive film pattern 50 shown in FIG. 3, the first resistive film pattern 150 according to the first modified example shown in FIG. 7. What is common to a pressure sensor including the first resistive film pattern 150 shown in FIG. 7 and the pressure sensor 10 exhibits similar effects brought by the pressure sensor 10 shown in FIGS. 1 to 6.

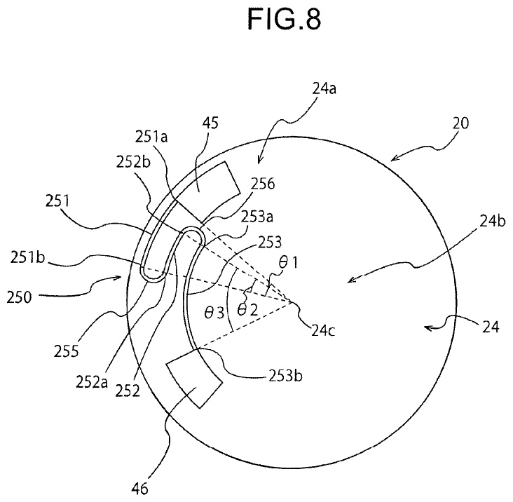

FIG. 8 is a schematic view of a shape of a first resistive film pattern 250 according to a second modified example and its arrangement with respect to the outer base surface 24. In FIG. 8, the outer base surface 24 of the stem 20 is illustrated in plan view from the first direction D1. However, in FIG. 8, among portions of the sensor unit provided on the outer base surface 24, illustrations of structures other than the first resistive film pattern 250 and the electrode pads 45 and 46 are omitted.

Similarly to the first resistive film pattern 50 shown in FIG. 2, the first resistive film pattern 250 shown in FIG. 8 is provided in the outer region 24a, which overlies the side wall 25 (see FIG. 4) in plan view from the first direction D1, of the outer base surface 24.

The first resistive film pattern 250 includes a first circumferentially oriented pattern portion 251, a second circumferentially oriented pattern portion 252, and a third circumferentially oriented pattern portion 253, which are circumferentially oriented pattern portions that extend along the circumferential direction and have different distances from the center 24c of the outer base surface 24. The first circumferentially oriented pattern portion 251, the second circumferentially oriented pattern portion 252, and the third circumferentially oriented pattern portion 253, which are the circumferentially oriented pattern portions, are connected with turns to constitute the first resistive film pattern 250. The first resistive film pattern 250 also includes a connecting portion 255, which connects the first circumferentially oriented pattern portion 251 and the second circumferentially oriented pattern portion 252, and a connecting portion 256, which connects the second circumferentially oriented pattern portion 252 and the third circumferentially oriented pattern portion 253.

The third circumferentially oriented pattern portion 253 is located least peripherally among the multiple (in the second modified example, three) circumferentially oriented pattern portions. At least a part of the first circumferentially oriented pattern portion 251, at least a part of the second circumferentially oriented pattern portion 252, and at least a part of the third circumferentially oriented pattern portion 253 are disposed concentrically with respect to the center 24c of the outer base surface 24. One end 251a of the first circumferentially oriented pattern portion 251 is connected to the electrode pad 45. An other end 251b of the first circumferentially oriented pattern portion 251 and one end 252a of the second circumferentially oriented pattern portion 252 are connected by the connecting portion 255 having a substantially semicircular shape with a larger curvature than curvatures of the circumferentially oriented pattern portions 251 and 252.

An other end 252b of the second circumferentially oriented pattern portion 252 and one end 253a of the third circumferentially oriented pattern portion 253 are connected by the connecting portion 256 having a substantially semicircular shape with a larger curvature than curvatures of the circumferentially oriented pattern portions 252 and 253. An other end 253b of the third circumferentially oriented pattern portion 253 is connected to the electrode pad 46.

As shown in FIG. 8, an angle θ3 subtended by an arc between the one end 253a and the other end 253b of the third circumferentially oriented pattern portion 253 at the center 24c is larger than an angle θ1 subtended by an arc between the one end 251a and the other end 251b of the first circumferentially oriented pattern portion 251 at the center 24c and an angle θ2 subtended by an arc between the one end 252a and the other end 252b of the second circumferentially oriented pattern portion 252 at the center 24c. The first circumferentially oriented pattern portion 251 and the second circumferentially oriented pattern portion 252 are the circumferentially oriented pattern portions other than the third circumferentially oriented pattern portion 253.

Because the third circumferentially oriented pattern portion 253, which is closest to the inner region 24b where the second resistive film pattern 60 is disposed, has a long length in such a first resistive film pattern 250, a discrepancy between a temperature detected by the first resistive film pattern 250 and an actual temperature of the second resistive film pattern 60 can be reduced.

The pressure sensor according to the present disclosure can include, instead of the first resistive film pattern 50 shown in FIG. 3, the first resistive film pattern 250 according to the second modified example shown in FIG. 8. What is common to a pressure sensor including the first resistive film pattern 250 shown in FIG. 8 and the pressure sensor 10 exhibits similar effects brought by the pressure sensor 10 shown in FIGS. 1 to 6.

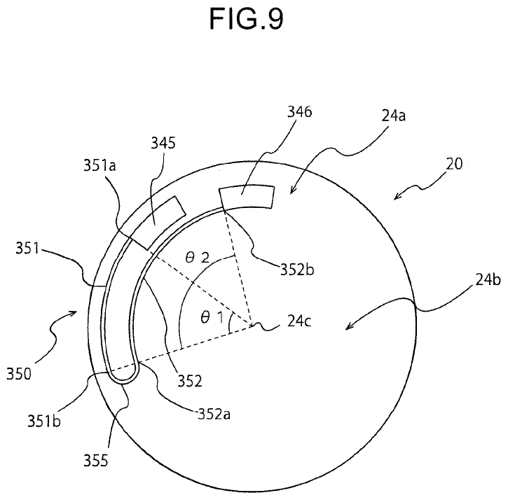

FIG. 9 is a schematic view of a shape of a first resistive film pattern 350 according to a third modified example and its arrangement with respect to the outer base surface 24. In FIG. 9, the outer base surface 24 of the stem 20 is illustrated in plan view from the first direction D1. However, in FIG. 9, among portions of the sensor unit provided on the outer base surface 24, illustrations of structures other than the first resistive film pattern 350 and electrode pads 345 and 346 are omitted.

Similarly to the first resistive film pattern 50 shown in FIG. 3, the first resistive film pattern 350 shown in FIG. 9 is provided in the outer region 24a, which overlies the side wall 25 (see FIG. 4) in plan view from the first direction D1, of the outer base surface 24.

The first resistive film pattern 350 includes a first circumferentially oriented pattern portion 351 and a second circumferentially oriented pattern portion 352, which are circumferentially oriented pattern portions that extend along the circumferential direction and have different distances from the center 24c of the outer base surface 24. The first circumferentially oriented pattern portion 351 and the second circumferentially oriented pattern portion 352, which are the circumferentially oriented pattern portions, are connected with a turn to constitute the first resistive film pattern 350. The first resistive film pattern 350 also includes a connecting portion 355, which connects the first circumferentially oriented pattern portion 351 and the second circumferentially oriented pattern portion 352.

The second circumferentially oriented pattern portion 352 is located least peripherally among the multiple (in the third modified example, two) circumferentially oriented pattern portions. At least a part of the first circumferentially oriented pattern portion 351 and at least a part of the second circumferentially oriented pattern portion 352 are disposed concentrically with respect to the center 24c of the outer base surface 24. One end 351a of the first circumferentially oriented pattern portion 351 is connected to the electrode pad 345. An other end 351b of the first circumferentially oriented pattern portion 351 and one end 352a of the second circumferentially oriented pattern portion 352 are connected by the connecting portion 355 having a substantially semicircular shape with a larger curvature than curvatures of the circumferentially oriented pattern portions 351 and 352. An other end 352b of the second circumferentially oriented pattern portion 352 is connected to the electrode pad 346.

As shown in FIG. 9, an angle θ2 subtended by an arc between the one end 352a and the other end 352b of the second circumferentially oriented pattern portion 352 at the center 24c is larger than an angle θ1 subtended by an arc between the one end 351a and the other end 351b of the first circumferentially oriented pattern portion 351, which is the circumferentially oriented pattern portion other than the second circumferentially oriented pattern portion 352, at the center 24c.

Because the second circumferentially oriented pattern portion 352, which is close to the inner region 24b where the second resistive film pattern 60 is disposed, has a long length and accounts for a large proportion of such a first resistive film pattern 350, a discrepancy between a temperature detected by the first resistive film pattern 350 and an actual temperature of the second resistive film pattern 60 can be reduced.

The pressure sensor according to the present disclosure can include, instead of the first resistive film pattern 50 shown in FIG. 3, the first resistive film pattern 350 according to the third modified example shown in FIG. 9. What is common to a pressure sensor including the first resistive film pattern 350 shown in FIG. 9 and the pressure sensor 10 exhibits similar effects brought by the pressure sensor 10 shown in FIGS. 1 to 6.

### Second Embodiment

FIG. 10 is a schematic view of a pressure sensor 410 according to a second embodiment of the present disclosure, illustrative of arrangement of an outer region 424a and an inner region 424b of an outer base surface 424, a first resistive film pattern 450, and a second resistive film pattern 60. Disposed at an upper part of FIG. 10 is a plan view of the outer base surface 424 of a stem 420 viewed from the first direction D1; and disposed at a lower part of FIG. 10 is a sectional view of the stem 420 in a section that is parallel to the first direction D1 and passes a center 424c of the outer base surface 424.

The pressure sensor 410 shown in FIG. 10 is different from the pressure sensor 10 shown in FIG. 4 and the like in that a side wall 425 of the stem 420 is thinner than the side wall 25 shown in FIG. 4 and that the first resistive film pattern 450 is partly disposed in a second outer region 424ab; however, in other respects, the pressure sensor 410 is similar to the pressure sensor 10. Description of the pressure sensor 410 is provided focusing on the differences from the pressure sensor 10. Parts common to the pressure sensors 410 and 10 are given the same reference numerals, and their description is omitted.

As shown in FIG. 10, the stem 420 of the pressure sensor 410 has a smaller thickness of the side wall 425 and a smaller area of the outer region 424a, particularly a first outer region 424aa of the outer region 424a, of the outer base surface 424, than those of the pressure sensor 10 shown in FIG. 4. Thus, a part of the first resistive film pattern 450, particularly a third circumferentially oriented pattern portion 453 disposed least peripherally among first to third circumferentially oriented pattern portions 451, 452, and 453, is provided in the second outer region 424ab of the outer region 424a.

As shown in FIG. 10, the side wall 425 includes a first side wall portion 425a and a second side wall portion 425b. A first inner surface 426a of the first side wall portion 425a extends in the first direction D1. A second inner surface 426b of the second side wall portion 425b faces a direction in between the first side wall portion 425a and an inner base surface 423 of a base wall 22. The second inner surface 426b of the second side wall portion 425b connects the first inner surface 426a of the first side wall portion 425a and the inner base surface 423.

The third circumferentially oriented pattern portion 453, which is a part of the first resistive film pattern 450, is provided in the second outer region 424ab, which overlies the second inner surface 426b of the second side wall portion 425b in plan view from the first direction D1. Note that, in plan view from the first direction D1, the first resistive film pattern 450 has a shape similar to that of the first resistive film pattern 50 shown in FIG. 3.

As shown in FIG. 6, the second outer regions 424ab and 24ab partly overlap an R-strain region 24e and tend to be under heavy strain (compression, −) along an R direction (radial direction) but are under light strain (tension, +) along a θ direction (circumferential direction). In the first resistive film pattern 450 shown in FIG. 10, only the third circumferentially oriented pattern portion 453 extending along the circumferential direction is provided in the second outer region 424ab. Even if at least a part of the first resistive film pattern 450 is in the second outer region 424ab in this manner, provided that the part is only a part extending along the circumferential direction or provided that most of the first resistive film pattern 450 extends along the circumferential direction, the resistance of such a first resistive film pattern 450 is less readily affected by strain of the outer base surface.

Similarly to the pressure sensor 10 including the first resistive film pattern 50 shown in FIG. 4, the pressure sensor 410 including the first resistive film pattern 450 shown in FIG. 10 can be further reduced in size while influence of strain of the outer base surface 424 can be mitigated in such a manner. That is, arranging a part of the first resistive film pattern near where the outer region and the inner region adjoin can further reduce the size of the pressure sensor while influence of strain of the outer base surface is mitigated. Other than that, what is common to the pressure sensor 410 shown in FIG. 10 and the pressure sensor 10 exhibits similar effects brought by the pressure sensor 10.

### Third Embodiment

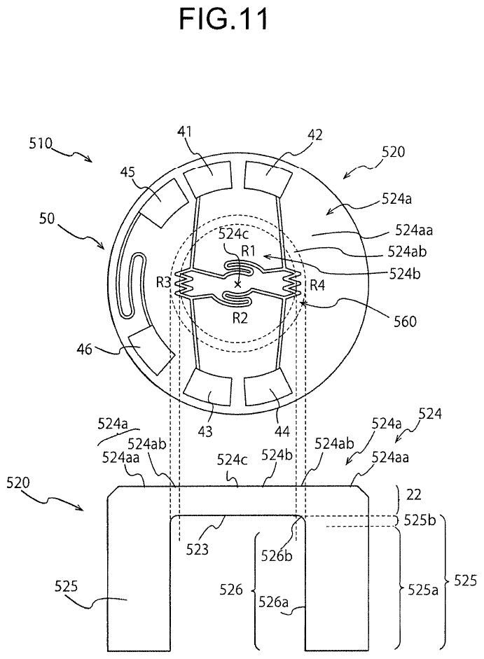

FIG. 11 is a schematic view of a pressure sensor 510 according to a third embodiment of the present disclosure, illustrative of arrangement of an outer region 524a and an inner region 524b of an outer base surface 524, a first resistive film pattern 50, and a second resistive film pattern 560. Disposed at an upper part of FIG. 11 is a plan view of the outer base surface 524 of a stem 520 viewed from the first direction D1; and disposed at a lower part of FIG. 11 is a sectional view of the stem 520 in a section that is parallel to the first direction D1 and passes a center 524c of the outer base surface 524.

The pressure sensor 510 shown in FIG. 11 is different from the pressure sensor 10 shown in FIG. 4 and the like in that a side wall 525 of the stem 520 is thicker than the side wall 25 shown in FIG. 4 and that the second resistive film pattern 560 is partly disposed in a second outer region 524ab; however, in other respects, the pressure sensor 510 is similar to the pressure sensor 10. Description of the pressure sensor 510 is provided focusing on the differences from the pressure sensor 10. Parts common to the pressure sensors 510 and 10 are given the same reference numerals, and their description is omitted.

As shown in FIG. 11, the stem 520 of the pressure sensor 510 has a larger thickness of the side wall 525 and a larger area of a first outer region 524aa of the outer base surface 524 but a smaller area of the inner region 524b of the outer base surface 524 than those of the pressure sensor 10 shown in FIG. 4. Thus, a part of the second resistive film pattern 560, particularly a part of a resistor R3 and a part of a resistor R4, is provided in the second outer region 524ab of the outer region 524a.

As shown in FIG. 11, the side wall 525 includes a first side wall portion 525a and a second side wall portion 525b. A first inner surface 526a of the first side wall portion 525a extends in the first direction D1. A second inner surface 526b of the second side wall portion 525b faces a direction in between the first side wall portion 525a and an inner base surface 523 of a base wall 22. The second inner surface 526b of the second side wall portion 525b connects the first inner surface 526a of the first side wall portion 525a and the inner base surface 523.

A part of the resistor R3 and a part of the resistor R4 of the second resistive film pattern 560 are provided in the second outer region 524ab, which overlies the second inner surface 526b of the second side wall portion 525b in plan view from the first direction D1. Note that, in plan view from the first direction D1, the second resistive film pattern 560 has a shape similar to that of the second resistive film pattern 60 shown in FIG. 4.

As shown in FIG. 6, the second outer regions 524ab and 24ab partly overlap an R-strain region 24e and tend to be under heavy strain (compression, −) along an R direction (radial direction). Thus, according to FIG. 6, it can be understood that, even if a part of the resistor R3 and a part of the resistor R4 of the second resistive film pattern 560 are provided in the second outer region 524ab, strain of the outer base surface 524 can be appropriately detected.

Other than that, what is common to the pressure sensor 510 shown in FIG. 11 and the pressure sensor 10 exhibits similar effects brought by the pressure sensor 10.

Hereinafter, a pressure sensor according to the present disclosure is described in more detail with reference to an example. However, this example does not limit pressure sensors according to the present disclosure.

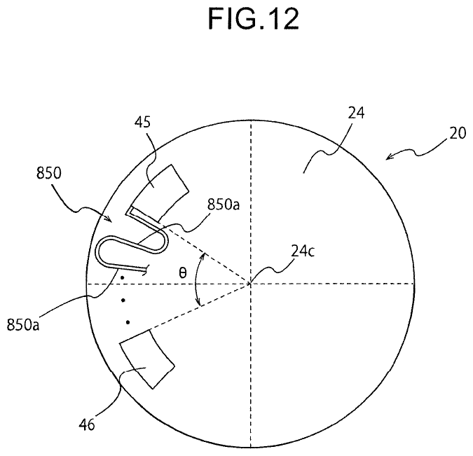

A pressure sensor 10 including a first resistive film pattern 50 on an outer base surface 24 of a stem 20 shown in FIG. 3 was prepared as an example model, whereas a pressure sensor including a first resistive film pattern 850 on an outer base surface 24 of a stem 20 shown in FIG. 12 was prepared as a reference example model. Portions of the pressure sensor according to the reference example other than the first resistive film pattern 850 were similar to those of the pressure sensor 10.

The first resistive film pattern 850 shown in FIG. 12 connected electrode pads 45 and 46, similarly to the first resistive film pattern 50 shown in FIG. 3. However, unlike the first resistive film pattern 50, the first resistive film pattern 850 included resistive film portions 850a extending along a radial direction (R direction); and these resistive film portions 850a in a pattern radiating from a center 24c were connected with turns to constitute the first resistive film pattern 850.

One end of the first resistive film pattern 850 was connected to the electrode pad 45, and an other end of the first resistive film pattern 850 was connected to the electrode pad 46. An angle θ formed between the one end and the other end of the first resistive film pattern 850 at the center 24c was the same as an angle formed between one end and an other end of the first resistive film pattern 50 shown in FIG. 3 at the center 24c. The length of, the number of, and the distance between the resistive film portions 850a constituting the first resistive film pattern 850 were determined so that the length and the resistance of the first resistive film pattern 850 shown in FIG. 12 were the same as those of the first resistive film pattern 50.

Further, for the pressure sensor 10 of the example model including the first resistive film pattern 50 and the pressure sensor of the reference example model including the first resistive film pattern 850, a simulation of calculating changes in the resistance of the first resistive film patterns 50 and 850 at the time of application of pressure was carried out. According to simulation results, the change in the resistance of the pressure sensor 10 of the example model including the first resistive film pattern 50 at the time of application of pressure was approximately half the change in the resistance of the pressure sensor of the reference example model including the first resistive film pattern 850.

As described above, the pressure sensors according to the present disclosure have been described with reference to the embodiments, the modified examples, and the example; however, the technical scope of the pressure sensors according to the present disclosure is not limited to these embodiments, modified examples, and example and, needless to say, includes many other embodiments and modified examples. For example, on an outer base surface of a pressure sensor, a resistive film pattern other than a first resistive film pattern and a second resistive film pattern may be provided. The shape of a connecting portion connecting circumferentially oriented pattern portions in plan view is not limited to an arc shown in FIG. 3. The connecting portion may, for example, linearly connect the circumferentially oriented pattern portions, or may have a width different from the widths of the circumferentially oriented pattern portions.

As is understood from the above description, the present specification discloses the following.
[1]

A pressure sensor including:
a stem including a base wall and a side wall extending in a first direction crossing the base wall;
a first resistive film pattern provided in an outer region of an outer base surface of the base wall, the outer region overlying the side wall in plan view from the first direction; and
a second resistive film pattern provided at least partly in an inner region of the outer base surface, the inner region not overlying the side wall in plan view from the first direction,
in which
the first resistive film pattern comprises circumferentially oriented pattern portions connected with a turn, the circumferentially oriented pattern portions extending along a circumferential direction and having different distances from a center of the outer base surface.
[2]

The pressure sensor according to [1], in which
the circumferentially oriented pattern portions include a first circumferentially oriented pattern portion located most peripherally; and
an angle subtended by a pattern between one end and an other end of the first circumferentially oriented pattern portion at the center is larger than an angle subtended by a pattern between one end and an other end of any of the circumferentially oriented pattern portions other than the first circumferentially oriented pattern portion at the center.
[3]

The pressure sensor according to [1] or [2], in which
the side wall includes a first side wall portion and a second side wall portion;
an inner surface of the first side wall portion extends in the first direction;
an inner surface of the second side wall portion faces a direction in between the first side wall portion and an inner base surface of the base wall and connects the inner surface of the first side wall portion and the inner base surface; and
the first resistive film pattern at least partly overlies the inner surface of the second side wall portion in plan view from the first direction.
[4]

The pressure sensor according to [1] or [2], in which
the side wall includes a first side wall portion and a second side wall portion;
an inner surface of the first side wall portion extends in the first direction;
an inner surface of the second side wall portion faces a direction in between the first side wall portion and an inner base surface of the base wall and connects the inner surface of the first side wall portion and the inner base surface; and
the first resistive film pattern entirely overlies the first side wall portion in plan view from the first direction.

### REFERENCE NUMERALS

10, 410, 510 . . . pressure sensor
12 . . . connecting member
12a . . . thread groove
12b . . . flow path
14 . . . holding member
18 . . . sensor unit
20, 420, 520 . . . stem
21 . . . flange portion
22 . . . base wall
23, 423, 523 . . . inner base surface
24, 424, 524 . . . outer base surface
24a, 424a, 524a . . . outer region
24aa, 424aa, 524aa . . . first outer region
24ab, 424ab, 524ab . . . second outer region
24e . . . R-strain region
24b, 424b, 524b . . . inner region
24d . . . θ-strain region
24c, 424c, 524c . . . center
25, 425, 525 . . . side wall
25a, 425a, 525a . . . first side wall portion
26, 426, 526 . . . inner surface
26a, 426a, 526a . . . first inner surface
25b, 425b, 525b . . . second side wall portion
26b, 426b, 526b . . . second inner surface
40 . . . insulating film
41, 42, 43, 44, 45, 46, 146, 345, 346 . . . electrode pad
50, 150, 250, 350, 450, 850 . . . first resistive film pattern
51, 151, 251, 351, 451 . . . first circumferentially oriented pattern portion
52, 152, 252, 352, 452 . . . second circumferentially oriented pattern portion
53, 253, 453 . . . third circumferentially oriented pattern portion
51a, 52a, 53a, 151a, 152a, 251a, 252a, 253a, 351a, 352a . . . one end
51b, 52b, 53b, 151b, 152b, 251b, 252b, 253b, 351b, 352b . . . other end
θ1, θ2, θ3 . . . angle
55, 56, 155, 255, 256, 355 . . . connecting portion
60, 560 . . . second resistive film pattern
R1, R2, R3, R4 . . . resistor
90 . . . circuit substrate
82 . . . connecting wire
850a . . . resistive film portion

What is claimed is:

1. A pressure sensor comprising:
a stem comprising a base wall and a side wall extending in a first direction crossing the base wall;
a first resistive film pattern provided in an outer region of an outer base surface of the base wall, the outer region overlying the side wall in plan view from the first direction; and
a second resistive film pattern provided at least partly in an inner region of the outer base surface, the inner region not overlying the side wall in plan view from the first direction,
wherein
the first resistive film pattern comprises circumferentially oriented pattern portions connected with a turn, the circumferentially oriented pattern portions extending along a circumferential direction and having different distances from a center of the outer base surface.

2. The pressure sensor according to claim 1, wherein
the circumferentially oriented pattern portions comprise a first circumferentially oriented pattern portion located most peripherally; and
an angle subtended by a pattern between one end and an other end of the first circumferentially oriented pattern portion at the center is larger than an angle subtended by a pattern between one end and an other end of any of the circumferentially oriented pattern portions other than the first circumferentially oriented pattern portion at the center.

3. The pressure sensor according to claim 1, wherein
the side wall comprises a first side wall portion and a second side wall portion;
an inner surface of the first side wall portion extends in the first direction;
an inner surface of the second side wall portion faces a direction in between the first side wall portion and an inner base surface of the base wall and connects the inner surface of the first side wall portion and the inner base surface; and
the first resistive film pattern at least partly overlies the inner surface of the second side wall portion in plan view from the first direction.

4. The pressure sensor according to claim 1, wherein
the side wall comprises a first side wall portion and a second side wall portion;
an inner surface of the first side wall portion extends in the first direction;
an inner surface of the second side wall portion faces a direction in between the first side wall portion and an inner base surface of the base wall and connects the inner surface of the first side wall portion and the inner base surface; and
the first resistive film pattern entirely overlies the first side wall portion in plan view from the first direction.
